(19) United States
(12) Patent Application Publication
(10) Pub. No.: US 2019/0047853 A1
(43) Pub. Date: Feb. 14, 2019

(54) METHOD OF GENERATING HYDROGEN FROM WATER SPLITTING AND A PHOTOELECTROCHEMICAL CELL FOR PERFORMING WATER SPLITTING

(71) Applicant: UNIVERSITY COLLEGE DUBLIN, NATIONAL UNIVERSITY OF IRLAND, DUBLIN, Dublin (IE)

(72) Inventor: Niall J. ENGLISH, Dublin (IE)

(73) Assignee: UNIVERSITY COLLEGE DUBLIN, NATIONAL UNIVERSITY OF IRELAND, DUBLIN, Dublin (IE)

(21) Appl. No.: 16/073,435

(22) PCT Filed: Jan. 25, 2017
(86) PCT No.: PCT/EP2017/051551

§ 371 Date: Jul. 27, 2018

(30) Foreign Application Priority Data
Jan. 27, 2016 (GB) 1601525.7

(51) Int. Cl. C01B 3/04; C01B 13/02; C25B 1/00; C25B 1/04; C25B 11/04

(52) U.S. Cl. CPC C01B 3/042; C01B 13/0207; C25B 11/0452; C25B 1/04; C25B 1/003

(57) ABSTRACT

A method of generating hydrogen from photoelectrochemical water splitting using a technique that combines an external electric field with light-driven water splitting. In particular, an electric field is applied at a semiconductor-water interface in a manner that boosts the efficiency and performance of photoelectrochemical water splitting, e.g. by selecting properties of the external electric field to increase susceptibility of water molecules to break up. The radiation that drives water-splitting may be solar radiation, which effectively represents a zero-cost energy input. The advantage of the invention arises because the increase in hydrogen generated that follows from application of the external electric field can have a calorific value greater than the energy required to generate the external electric field. The external electric field thus has a quasi-catalytic effect to promote more efficient conversion of the radiation into hydrogen.

### CROSS-REFERENCE TO RELATED APPLICATIONS

This is a U.S. national phase application under 35 U.S.C. § 371 of International Patent Application No. PCT/EP2017/051551, filed Jan. 25, 2017, and claims benefit of priority to Great Britain Patent Application No. GB 1601525.7, filed Jan. 27, 2016. The entire contents of these applications are hereby incorporated by reference.

### FIELD OF TECHNOLOGY

The invention relates to a photochemical process for producing hydrogen from water in all its guises, such as seawater, salty water and wastewater. In particular, the invention relates to the use of solar radiation to perform water splitting, to obtain H₂ gas.

### BACKGROUND

At present, conversion efficiencies of incident solar radiation to liquid fuels are only a few percent. The harvesting of about 0.3-0.5% of incident solar radiation (the total being ˜120,000 TW) and conversion to H₂ at a solar-to-hydrogen (STH) efficiency of around 9-10% would meet the domestic, transport and industrial needs of the world's population, helping to realise the ‘Hydrogen Economy’.

The crucial advantage of solar energy is the ubiquitous nature of sunlight and the vast potential energy to be harnessed from solar irradiation of the Earth. Although solar energy is diffuse and is subject to diurnal and seasonal fluctuation, together with transient atmospheric effects (e.g., cloud), solar-energy systems do, in large part, overcome the fundamental problem of intermittency and volatility in supply associated with other forms of renewable energy, such as wind and wave energy.

However, no system including a single photo-absorber has shown both truly efficient and economic water splitting up to this point [1]. Combining a photo-electrode with a photovoltaic (PV) cell in a ‘tandem cell’ device provides more opportunity for combination of materials, and there has been much promising activity in the past decade [2-6], with the very recent reporting of a 12.3% efficient (STH) perovskite-based cell based on abundant and inexpensive materials, albeit unstable [6]. Indeed, the search for an operationally straightforward and inexpensive way of boosting STH performance based on photoelectrochemical water splitting on abundant metal-oxide semiconductors has even been described as the ‘Holy Grail’ of chemistry [7], and has been subject to many decades of intensive effort, both before, and especially after, the pioneering work of Fujishima and Honda with titania [8].

### SUMMARY

At its most general, the invention concerns the application of electric fields at semiconductor-water interfaces in a manner that boosts the efficiency and performance of photoelectrochemical water splitting. Although H₂ production from water mediated by electric fields has received considerable attention outside of electrolysis, such as by ionisation [9] and plasma methods [10, 11] the combination of an external electric field with light-driven water splitting has not been reported.

In one aspect, the invention provides a method of generating hydrogen from photoelectrochemical water splitting, the method comprising: providing a photoelectrochemical cell having a semiconductor photoanode and a photocathode in contact with water; irradiating the photoelectrochemical cell with radiation selected to promote electrons in the semiconductor photoanode to the conduction band; generating an external electric field across an interface between the semiconductor photoanode and water, wherein properties of the external electric field are selected to increase susceptibility of water molecules to break up. The radiation may be solar radiation, which effectively represents a zero-cost energy input for the method. By appropriate selection of the properties of the external electric field, the increased susceptibility of water molecules to break up can yield an increase in hydrogen generation within the photoelectrochemical cell compared with a zero-field set-up, i.e., the absence of the external electric field. The advantage of the invention arises because the increase in hydrogen has a calorific value greater than the energy required to generate the external electric field. The external electric field thus has a quasi-catalytic effect to promote more efficient conversion of the radiation into hydrogen.

The radiation for promoting electrons in the semiconductor photoanode to the conduction band may come from any suitable source. For example, the radiation may be optical radiation, e.g. in the visible spectrum. The radiation may be natural sunlight (e.g. solar radiation) or artificial light from a suitable light source. The energy efficiency of the method is optimised if the radiation is naturally occurring.

The external electric field may be of any type that is capable of affecting the water molecules. The external electromagnetic field may be applied in a continuous manner, or may be pulsed, e.g. using stepped or Gaussian-type pulses.

The external electric field may be a static electric field. This type of field can cause the alignment of the water molecules' dipoles to increase the susceptibility of water molecules to break up. This field also acts to reduce electron-hole recombination and to increase charge carrier diffusivity in the semiconductor anode. Both of these effects also increase the likelihood of a water-molecule break-up event.

Alternatively, the external electric field may be a dynamic (i.e. time-varying) electromagnetic field having a frequency selected such that oscillation of the field have a period that is the same order of magnitude as the relaxation time of hydrogen bonds in the water. The dynamic electromagnetic field may provide the same advantageous effects as the static field. However, in addition to these effects, the dynamic electromagnetic field can effectively increase the frequency at which hydrogen bonds in the water naturally break and reform. This effect further increases the susceptibility of water molecules to break up upon absorption of a photo-excited hole of the light-absorbing, semiconducting substrate.

The relaxation time of hydrogen bonds in water is typically in the order of picoseconds, e.g. 5-10 ps, so the frequency of the dynamic electromagnetic field may be greater than 100 GHz, and is preferably in the range 500 to 1000 GHz.

The method may include setting an electric-field strength for the external electric/electromagnetic field to be less than a thermal excitation threshold. Whilst the advantageous effects of the invention occur because the external electric/electromagnetic field has an effect on one or more of the orientation, translational motion and rotational motion of the water molecules, such advantageous effects may be lost when the molecules become too thermally excited.

If the external electric field is a continuously applied static electric field, the thermal excitation threshold may be 200 V/m or less.

If the external electric field is a time-varying electromagnetic field, the RMS electric-field strength may be setting to be less than the thermal excitation threshold. In this case, the thermal excitation threshold may be equal to or less than 50 V/m. Fields of this type may be generated by a magnetron operating at a power equal to or less than 15 W, e.g. in the range 10 to 15 W.

Any type of water may be used, e.g. seawater, salty water, river water, municipal water and wastewater. However, the effect of the electric field can be further enhanced if the water has an ionic compound dissolved therein. The field causes translational motion of the ions through the water molecules, which is an additional disturbance that can increase the susceptibility of the water molecules to break up.

The ionic compound may have a concentration of greater than 0.5 M. Any suitable (i.e. readily available and water soluble) ionic compound may be used. For example, the ionic compound may be NaOH or NaCl. In one example, the water may be sea water.

The external electromagnetic field may be an elliptically or circularly polarized electromagnetic field. This type of field can induce rotational or twisting motion of the dipoles in the water molecules, which has the effect of increasing the susceptibility of water molecules to break up.

The method may include harvesting hydrogen generated in the photoelectrochemical cell according to any known technique.

The semiconductor photoanode may comprise a photo-absorbing metal oxide. In general, the typical band-gap range of the photo-absorbing substrate would be in the ˜1.8-3.3 eV range. Examples of semiconductor photoanodes include metal oxides such as titanium dioxide or iron oxide (e.g., hematite form thereof).

In another aspect, the invention provides an apparatus for photoelectrochemical generation of hydrogen from water splitting, the apparatus comprising: a photoelectrochemical cell having: an anode compartment and a cathode compartment in fluid communication with one another, the anode compartment and cathode compartment being arranged to receive water, a semiconductor photoanode mounted in the anode compartment to contact water held therein, a photocathode mounted in the cathode compartment to contact water held therein, circuitry to permit charge transfer between the photoanode and photocathode; an electric-field generator arranged to apply an external electric field across an interface between the semiconductor photoanode and water, wherein the photoelectrochemical cell is transparent to radiation capable of promoting electrons in the semiconductor photoanode to the conduction band, and wherein the electric-field generator is arranged to set properties of the electric field which increase susceptibility of water molecules to break up. The apparatus is thus configured to perform the method set out above. Accordingly, features explained with respect to the method above can have also be present in the apparatus.

The photoelectrochemical cell may have a conventional configuration. For example, the photoelectrochemical cell may be transparent to or comprise a window that is transparent to solar radiation.

The electric-field generator may include a pair of plate electrodes arranged on opposite sides of the photoelectrochemical cell. The plates may be transparent, or may be positioned in a manner that does not interfere with (i.e. block) incoming radiation. With this configuration, the external electromagnetic field can be applied across the anode compartment and the cathode compartment. It may be desirable for the effects of the electromagnetic field to be experienced substantially uniformly across the interface in the photoelectrochemical cell. In one example, each of the pair of plate electrodes may be sized to generate a substantially uniform field within the photoelectrochemical cell.

In an embodiment, the electric-field generator may comprise a voltage source for applying a static electric field across the interface between the semiconductor photoanode and the water. For example, the voltage source may include a commercially available static-field or pulsed-field emitter. The voltage source may have an output power selected such that an electric field strength for the external electric field is less than a thermal excitation threshold. The thermal excitation threshold may be equal to or less than 200 V/m for a static field.

In another embodiment, the electromagnetic field generator may include a microwave source for applying a dynamic (i.e. time-varying) electromagnetic field across the interface between the semiconductor photoanode and the water, the dynamic electromagnetic field having a frequency selected such that oscillation of the field have a period that is the same order of magnitude as the relaxation time of hydrogen bonds in the water. The microwave source may be arranged to output electromagnetic energy having a frequency greater than 100 GHz, and preferably in the range 500 to 1000 GHz. The microwave source may be a commercially available magnetron or the like.

The microwave source may have an output power selected such that an RMS electric field strength for the external electromagnetic field is less than a thermal excitation threshold. The thermal excitation threshold may be equal to or less than 50 V/m.

The electric field strength or RMS electric field may be set in advance. Alternatively, a feedback loop for determining the optimal field intensity (and frequency, where applicable) can be followed, wherein the calorific value of the hydrogen production rate is gauged vis-à-vis the energy required to generate the external electric field.

The electric-field generator may include a polarized element arranged to generate an elliptically or circularly polarized electromagnetic field.

The apparatus may be arranged to collect the hydrogen generated in the photoelectrochemical cell. This may be done in any known manner. For example, the photoelectrochemical cell may include a gas outlet arranged to convey generated hydrogen to a suitable harvesting device.

The semiconductor photoanode may have a physical shape that provide a high surface-area-to-volume ratio to maximise the area capable of receiving the radiation.

### BRIEF DESCRIPTION OF THE DRAWINGS

Examples of the invention are discussed below with reference to the accompanying drawings, in which:

FIG. 1 is a schematic drawings illustrating the concept underlying the invention;

FIG. 2 is a graph showing number of water break-up events (normalised per unit area) predicted based on simulation data;

FIG. 3 is a schematic view of a solar cell that is an embodiment of the invention; and

FIG. 4 is a graph showing predicted efficiency (net energy return) for various water samples based on simulation data.

### DETAILED DESCRIPTION; FURTHER OPTIONS AND PREFERENCES

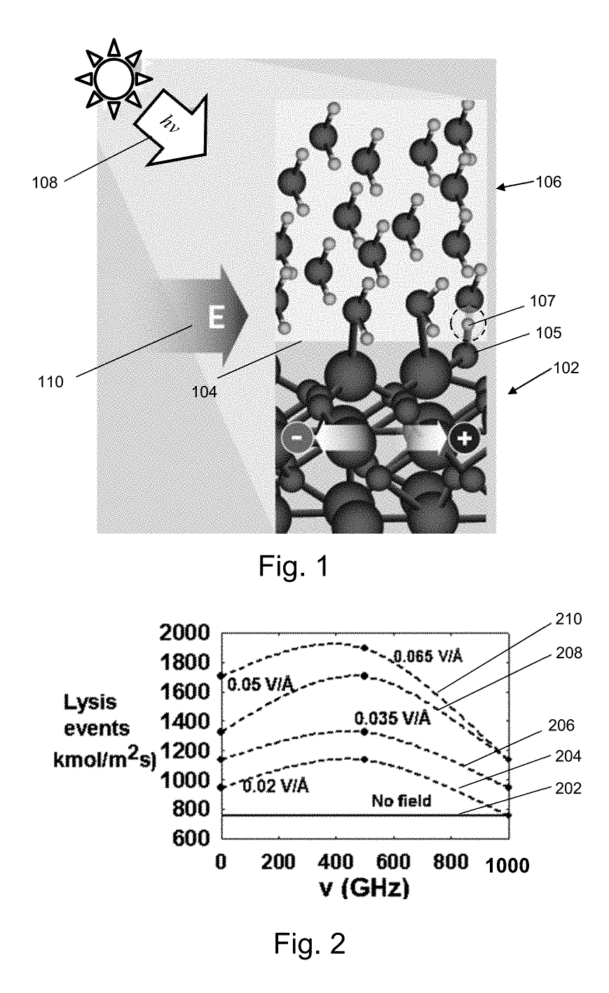

FIG. 1 illustrates schematically the modus operandi of an external electric field boosting water splitting [12]. In FIG. 1, a photoabsorber (e.g. a photoanode) made from a suitable semiconductor 102 (e.g. hematite-iron oxide) is arrange to have an outer surface 104 (which is along a 001 crystal plane of the hematite in this example) in contact with water 106. The present invention is concerned with increasing the susceptibility of the water molecules to break up in this environment. Water splitting may produce hydrogen that can be harvested by any known technique.

The invention can utilise a number of factors to influence the susceptibility of a water molecule to break up at a photoabsorber/water interface, as explained below.

Surface hydroxylation, i.e. the formation of hydroxyl groups at a surface, occurs at the water-hematite interface due to partial chemical adsorption of water. For example, a bridging oxygen atom 105 at the outer surface 104 may be hydroxylated by a hydrogen atom (i.e. proton) 107 from a water molecule. This interaction has been observed for titania [13-15] as well as hematite [12]. The strain on the water molecule caused by this hydroxylation can cause the water molecule to break up, whereby hydrogen is released. In the absence of other external influences, this process generates a negligible amount of hydrogen gas because the released hydrogen atoms bond covalently to other surface oxygen atoms on the photoanode surface. However, as discussed below, in the presence of electron-exciting radiation and an external electric field, this process can be enhanced in a manner that causes a non-negligible amount of hydrogen gas to be released.

In the arrangement shown in FIG. 1, the water-hematite interface is irradiated by radiation 108 that consists of or includes a frequency ν such that energy of photons in the radiation 108 can cause an electron in the hematite to be promoted to the conduction band, thereby making an electron-hole pair. This effect can promote surface hydroxylation and therefore hydrogen release by enhancing contact between water molecules and holes at the outer surface.

As shown in FIG. 1, the invention goes further by applying an electric field 110. This causes the electron and hole to drift apart, e.g. in opposite directions, due to their opposite charge. The electric field effectively breaks symmetry so as to enhance electron-hole transport [16, 17]. This enhanced drift mitigates substantially the problem of electron-hole recombination and serves to enhance further contact of holes with water at the surface of the hematite, thereby facilitating water break-up.

Moreover, the electric field causes alignment of the water molecules' dipoles. This prevents the relative orientation of adjacent water molecules in a manner that increases intramolecular strain. This effect can also facilitate water break-up.

There are two further factors that can facilitate water break-up: (i) the presence of ions in the water, and (ii) suitable variation of the electric field.

If ions are present in the water, e.g. by dissolving a suitable substance, such as salt, NaOH or the like, the effect of the electric field is enhanced. This is because the electric field induces translational movement of the ions, which has the effect of disturbing the water molecules in a manner that makes the bonding of hydrogen in the water molecules more prone to break up.

Variation of the electric field may facilitate water break-up in a similar manner by causing motion which disturbs the hydrogen bonding. The variation of the electric field can be the change (preferably oscillation) of a property of the field over time.

In one example, the amplitude of the applied field may oscillate at a suitable frequency. Where ions are present, this oscillation can cause back and forth translation of the ions within the water molecules, which disturbs the hydrogen bonding in a similar way to that discussed above.

However, a time-varying electric field may be effective even in the absence of ions. For example, if the period of the time varying electric field is chosen to be of the same order as the relaxation period of the hydrogen bonds, a quasi-resonant effect occurs in which the frequency of hydrogen bonds break and reform increases, which in the presence of holes thereby increases the susceptibility of water molecules to break up. Relaxation periods for hydrogen bonds in water are typically in the order of a picosecond (10⁻¹² s). The frequency of the time varying electric field may correspond to such period, e.g. may be of the order of terahertz (10¹² Hz). For example, frequencies in the range 100-1000 GHz may be used.

The oscillation of nuclei in the electric field may also improve diffusion of electrons and holes to the surface of the hematite [18]. In some circumstances the diffusivity period of the substrate material may be of a similar order to the time variation of the electric field. However, any degradation in diffusion is negligible compared with the improvement to water splitting susceptibility.

In another example, the variation of the electric field may be a change in polarization. For example, the electric field may be circularly polarized so that the direction of the electric field vector component varies with time. This has the effect of rotating or twisting the water molecules' dipoles, which disturbs the hydrogen bonding in a similar way to that discussed above.

As discussed above, in an electric field the water molecules' dipoles align with the field [19], which represents a change in state from an initial, essentially random (i.e. net zero) dipolar alignment. In alternating fields, the water molecules' dipoles rotate back and forth with the field as it changes direction [20-22], which can lead to substantial intramolecular strain, enhancing yet further the rate of water break-up. This may also serve to increase further chemical adsorption of hydrogen onto bridging oxygen atoms at the surface.

The subtle interplay between the electric field 110 and the radiation 108 rests upon a balance between enhanced electron-hole drift in lower-frequency fields and optimal overlap of external-field frequencies with dipole-reorientational alignment [21,23,24], which is typically in the microwave region.

Also, the introduction of chemical/elemental dopants into the photo-absorbing semiconductor 102 can create intrinsic electric fields, which may enhance the creation of photo-excited holes and electrons, thereby further enhancing this external-field-induced/enhanced process. Judicious combination of intrinsic (e.g., from dopants) and external electric fields may be exploited to enhance further solar-hydrogen production from water-splitting.

The examples discussed below examine the effect of the addition of an electric field on H₂ production using solar radiation. Non-equilibrium molecular dynamic simulations are performed to evaluate frequency—and intensity—effects on water-splitting events.

The simulation-based data is obtained from a non-equilibrium Born-Oppenheimer molecular dynamics (NE-BOMD) study carried out on water in contact with a 001 hematite/iron-oxide interface in the presence of both an external static electric field and a time varying electromagnetic field.

Ground-state simulations were performed in a known manner [12]. The static electric and varying electromagnetic fields were implemented with static and electromagnetic root mean square (r.m.s.) electric-field intensities of 0.02, 0.035, 0.05 and 0.065 V/Å, and electromagnetic-field frequencies of 500 and 1000 GHz [21]. The field intensities were selected to ensure that tangible effects would be observable over a period amenable to NE-BOMD (generally, no more than tens of picoseconds). In these examples, the simulations were performed for a time period of ˜12 ps, so as to allow for at least a half-dozen electromagnetic field cycles, with appreciable dipolar orientation of the water molecules occurring rapidly on sub-picosecond timescales. However, it must be noted that the duration of this simulation is limited by computer processing demand, and that in practice the electric field is likely to be applied for longer periods, and therefore the field intensity would be much less in order to avoid introducing unwanted heating effects. For example, in practice the field strength would be around 200 V/m or less.

For the varying electromagnetic fields, the 500 and 1000 GHz frequencies were chosen due to their respective periods of 2 and 1 ps, which overlap the typical individual dipole and H-H NMR rotational relaxation times in liquid water [28].

Nuclear point charges were taken as averages of Bader charges [25] averaged from an equilibrium BOMD simulation [12], to allow for field coupling [21] using a Nosé-Hoover thermostat in the NVT ensemble at 298 K with a relaxation time of 0.2 ps [26]. For water, it has been established that ˜0.05 V/Å is a threshold for which non-linear field behaviour starts to take effect in non-equilibrium molecular dynamics (NEMD), in terms of induced rotational and translational diffusive motion [21-24], so it is not desirable to apply fields more intense than this.

In condensed phases of water, molecular dynamics has shown that a local electric field is in the range of ˜1.5 to 2.5 V/Å [21], which gives rise to de facto ‘signal-to-noise’ ratios of between ˜20:1 and 120:1 for intrinsic to applied fields in the simulations presented here. Field strengths in the 0.1-0.5 V/Å range may be obtained in experiment by applications of potentials of 1 to 5 kV onto tips of radius 10-100 nm [27].

FIG. 2 is a graph depicting the number of water splitting events recorded over the duration of the simulations discussed above. Line 202 represented the ground state (no field) simulation. For each of the field intensities 0.02 V/Å, 0.035 V/Å, 0.05 V/Å and 0.065 V/Å, values obtained from simulation for (i) a static field, (ii) a 500 GHz varying field, and (iii) a 1000 GHz varying field, were plotted an extrapolated to arrive at respective lines 204, 206, 208, 210.

It can be seen that up to the linear-response regime limit of ˜0.05 V/Å, the predicted number of break-up events increases by up to ˜70% for electromagnetic fields at 500 GHz vis-à-vis the zero-field level (characteristic of ‘native’ hydroxylation of an initially-anhydrous surface). This increase is greater than that of a static field (the ‘zero’ frequency in FIG. 2), in which the level of dipolar alignment is preserved, and is also more than increase observed at 1000 GHz. The 2 ps period for the 500 GHz field is closer to typical individual-dipole intrinsic relaxation times [28] offering increased scope for greater levels of alignment and concomitant strain.

The number of water splitting events is ‘scaled up’ per unit area and time for plotting in FIG. 2 from the ˜12 ps trajectories, from an initially anhydrous surface. This will be greater than ‘steady state’ due to the initially anhydrous nature of the surface.

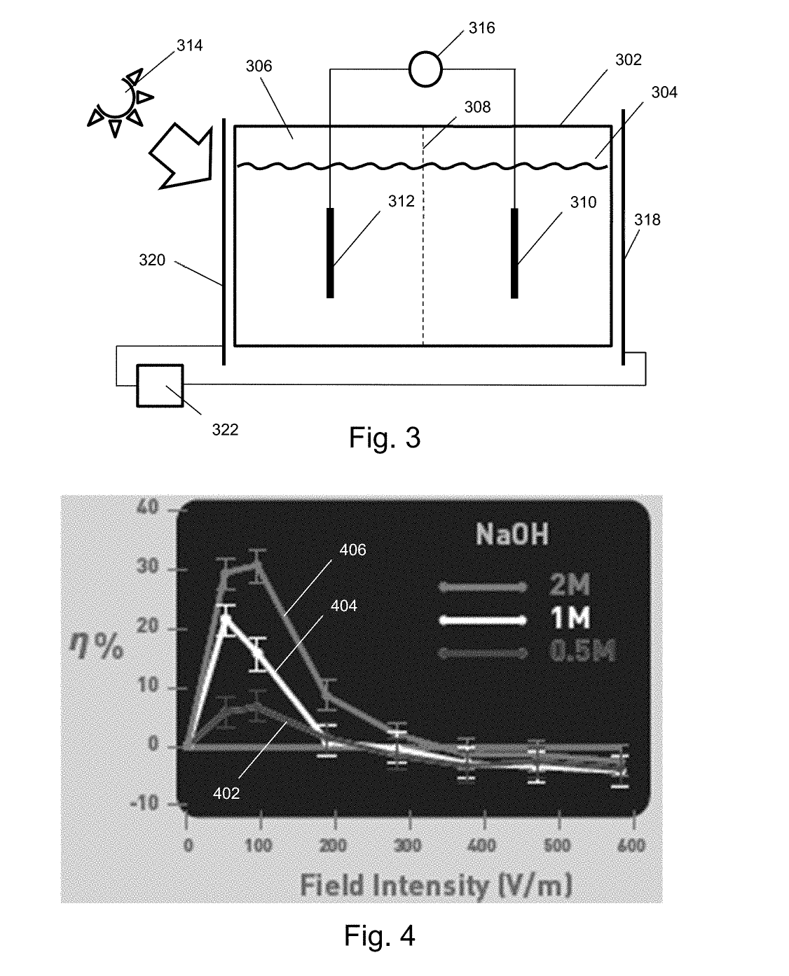

The NE-BOMD simulation results shown in FIG. 2 offer, to some extent, a limited proof of concept. FIG. 3 illustrates schematically an apparatus 300 that provides a practical set up used for the purposes of experimental validation.

FIG. 3 shows a open-type transparent photo-electrochemical cell 302 having two compartments 304, 306 separated by a porous membrane 308, similar to known cell designs [29, 30]. The cell 302 includes an outlet (not shown) arranged to convey generated hydrogen to a separate collection or storage apparatus (not shown). In the experiments run using this apparatus, the compartments 304, 306 contained aqueous sodium hydroxide solution at various concentrations (0.5, 1 and 2 M).

A photoanode 310 having rutile-titania surface was placed in one of the compartments 304. A photocathode 312 of platinum was placed in the other compartment 306. Experiments were run using photoanode surface areas of approximately 0.5, 1 and 2 cm².

The cell 302 was exposed to an AM 1.5 light source 314.

The cell 302 is mounted between a pair of external electrodes 318, 320, which are connected to a voltage source 322 to apply an external electric field across the cell. The electrodes are positioned in a way that does not inhibit radiation from the light source 314 from reaching the photoanode 310.

A value for a solar-to-hydrogen (STH) parameter was obtained using photocurrent measurements from a detector 316. Four independent readings were taken in the absence and presence of static (DC) electric fields at each NaOH concentration. The zero-field values were 0.38±0.023, 0.54±0.031 and 0.71±0.035% in 0.5, 1 and 2M solutions, respectively. STH was measured in a standard way by gauging the photocurrent vis-à-vis the radiant-power content of the light source 314 [32].

A DC field was applied across the cell. The field intensity was inferred from the voltage applied by the voltage source 322 and separation of the electrodes 318. 322. The experiment was repeated three times under each experimental condition.

FIG. 4 shows graphically the results of this study. In this figure the efficiency η (net energetic return) provides a measure of additional calorific output vis-à-vis the field's energy input. This is determined using the following equation

$$η = \frac{Δ {W}_{{H}_{2}} - δ {W}_{E}}{δ {W}_{E}} \qquad ( 1 )$$

where W_{H}_{₂} is the calorific equivalent of H₂ arising from photoelectrochemical water splitting in the absence of any field defined by photocurrent, whilst ΔW_{H}_{₂} is the additional calorific equivalent of H₂ produced from exposure to the field E and its energy input δW_{E}. In these experiments there was no appreciable H₂ produced in the absence of light, even with electric fields applied.

For the 1 cm²-area photo-anode, the efficiency η is plotted in FIG. 4 as a function of field strength for the three aqueous concentrations of NaOH. Line 402 is for the 0.5 M concentration. Line 404 is for the 1 M concentration. Line 406 is for the 2 M concentration. The efficiency is zero by definition at zero intensity (no field applied).

Above ˜300 V/m, there is thermal dissipation due to heating of the liquid by the electric field [31]. This therefore represents an upper limit on the field intensity that can be utilised to achieve the advantageous effects of the invention.

However, there is an optimal ‘payback’, where η reaches around 7±2.5, 21±3 and 30±4% for 0.5, 1 and 2 M, respectively, in the ˜50-100 V/m region, due to the favourable interplay of sunlight and electric field explained above. The increase in STH at these ‘peak’ additional H₂ evolution levels at the 0.5, 1 and 2 M NaOH were ˜3.5, 8 and 12%, respectively.

Similar results were found for the 0.5- and 2 cm²-area photoanodes. For the 0.5 cm2 area, the η values were generally 12-18% lower compared with the 1 cm²-area values. This was likely due to edge effects of a smaller photoanode.

Based on a non-equilibrium Born-Oppenheimer molecular dynamics (NE-BOMD) simulation study, it is predicted that the number of H₂O break-up events can increase by up to ˜70% for electromagnetic fields at 500 GHz compared with a zero-field level. Experimentally, it has been demonstrated that the addition of a DC electric field increases PEC efficiency for H₂ evolution by up to 12%. Given that this experimental work was carried out using a relatively poor photoabsorber (titania), it likely that similar electric fields will have substantial transformational potential on the operation and economics of more photoactive materials.

The advantageous effects of the invention arise in part by demonstrating how a balance can be achieved between rotational and librational response of water in terms of induced intramolecular strain, as compared to increase in electron-hole drift and diffusion in the substrate vis-à-vis field frequency. When designing a practical system, it may also be desirable to take account of the substrate's dielectric properties, which affect the extend to which the static or varying field is absorbed.

Fundamentally, however, the approach presented herein may be capable of being scaled up and applied to other metal oxides and differing morphologies thereof in order to bolster efforts to realise the Hydrogen Economy from solar sources.

### REFERENCES

[1] O. Khaselev and J. A. Turner, Science, 1998, 280, 425.

[2] M. Grätzel, Cat Tech, 1999, 3, 3

[3] M. Grätzel, Nature, 2001, 414, 338

[4] M. Barroso, A. J. Cowan, S. R. Pendlebury, M. Grätzel, D. R. Klug and J. R. Durrant, J. Am. Chem. Soc., 2011, 133, 14868.

[5] M. Barroso, C. A. Mesa, S. R. Pendlebury, A. J. Cowan, T. Hisatomi, K. Sivula, M. Grätzel, D. R. Klug and J. R. Durrant, Proc. Nat. Acad. Sci., 2012, 109, 15640.

[6] J. Luo, J.-H. Im, M. T. Mayer, M. Schreier, M. K. Nazeeruddin, N.-G. Park, S. D. Tilley, H. J. Fan and M. Grätzel, Science, 2014, 345, 1593-1596.

[7] L. Rovelli and K. R. Thampi, ‘Solar water splitting using semiconductor systems’ In: Jacinto Sá (ed.) ‘Fuel production with heterogeneous catalysis.’ CRC Press, Taylor & Francis, Boca Raton, Fla., USA (2015).

[8] A. Fujishima and K. Honda, Nature 1972, 238, 37-38.

[9] D. Haitin and R. Gan, U.S. Pat. No. 8,337,766 (2012)

[10] T. Mizuno, T. Akimoto and T. Ohmori, ‘Confirmation of anomalous hydrogen generation by plasma electrolysis’, 4th Meeting of Japan CF Research Society, Iwate University, Iwate, Japan (2003).

[11] N. Boudesocque, C. Vandensteendam, C. Lafon, C. Girold and J. M. Baronnet, ‘Hydrogen production by thermal water splitting using a thermal plasma’, 16th World Hydrogen Energy Conference, Lyon, France, 13-16 Jun. 2006.

[12] N. J. English, M. Rahman, N. Wadnerkar and J. M. D. MacElroy, Phys. Chem. Chem. Phys., 2014, 16, 14445.

[13] C. Z. Liu, G. Thornton, A. Michaelides, Phys. Rev. B 2010, 82, 161415.

[14] D. J. Wesolowski, J. O. Sofo, A. V. Bandura, Z. Zhang, E. Mamontov, M. Prědota, N. Kumar, J. D. Kubicki, P. R. C. Kent, L. Vlcek, M. L. Machesky, P. A. Fenter, P. T. Cummings, L. M. Anovitz, A. A. Skelton, J. Rosenqvist, Phys. Rev. B 2012, 85, 167401.

[15] M. L. Li, C. Zhang, G. Thornton, A. Michaelides, Phys. Rev. B 2012, 85, 167402.

[16] S. J. Fonash, Solar-Cell Device Physics, Elsevier, 2010.

[17] V. Abramavičius, D. A. Vithanage, A. Devižis, Y. Infahsaeng, A. Bruno, S. Foster, P. E. Keivanidis, D. Abramavičius, J. Nelson, A. Yartsev, V. Sundström and V. Gulbinas, Phys. Chem. Chem. Phys., 2014, 16, 2686.

[18] N. J. English, D. C. Sorescu and J. K. Johnson, J. Phys. Chem. Solids, 2006, 67, 1399-1409.

[19] N. J. English, D. A. Mooney and S. W. O'Brien, J. Molec. Liquids, 2010, 157, 163-167.

[20] N. J. English and J. M. D. MacElroy, J. Chem. Phys., 2003, 118, 1589-1592.

[21] N. J. English and J. M. D. MacElroy, J. Chem. Phys., 2003, 119, 11806-11813.

[22] N. J. English, Molec. Phys., 2006, 104, 243-253.

[23] R. Reale, N. J. English, P. Marracino, M. Liberti and F. Apollonio, Chem. Phys. Lett. 2013, 582, 60-65.

[24] R. Reale, N. J. English, P. Marracino, M. Liberti and F. Apollonio, Molec. Phys. 2014, 112, 1870-1878.

[25] E. Sanville, S. D. Kenny, R. Smith and G. Henkelman, J. Comp. Chem. 2007, 28, 899

[26] W. G. Hoover, Phys. Rev. A 1985, 31, 1695-1697.

[27] D. L. Scovell, T. D. Pinkerton, V. K. Medvedev and E. M. Stuve, Surf Science., 2000, 457, 365.

[28] N. J. English, Molec. Phys. 2005, 103, 1945-1960.

[29] M. Antoniadou, S. Sfaelou and P. Lianos, Chem. Eng. J., 2014, 254, 245-251.

[30] Z. Liu, B. Pesic, K. S. Raja, R. R. Rangaraju and M. Misra, Int. J. Hydrogen Energy, 2009, 34, 3250-3257.

[31] A. C. Metaxas and R. J. Meredith, Industrial Microwave Heating, Peter Peregrinus, London, 1983.

[32] A. Rothschild, J. Phys. Chem. Lett. 5, 3330 (2014)

1. A method of generating hydrogen from photoelectrochemical water splitting, the method comprising:
providing a photoelectrochemical cell having a semiconductor photoanode and a photocathode in contact with water;
irradiating the photoelectrochemical cell with radiation selected to promote electrons in the semiconductor photoanode to the conduction band; and
generating an external electromagnetic field across an interface between the semiconductor photoanode and water,
wherein properties of the electromagnetic field are selected to increase susceptibility of water molecules to break up.

2. The method of claim 1, wherein the external electromagnetic field is a static electric field.

3. The method of claim 1, wherein the external electromagnetic field is a dynamic electromagnetic field having a frequency selected such that oscillation of the field have a period that is the same order of magnitude as the relaxation time of hydrogen bonds in the water.

4. The method of claim 3, wherein the frequency is greater than 100 GHz.

5. (canceled)

6. The method of claim 1, wherein the external electromagnetic field is an elliptically polarized electromagnetic field.

7. The method of claim 1 including setting an electric field strength for the external electromagnetic field to be less than a thermal excitation threshold, wherein the external electromagnetic field is a static electric field and the thermal excitation threshold is equal to or less than 200 V/m.

8. (canceled)

9. The method of claim 1 including setting an electric field strength for the external electromagnetic field to be less than a thermal excitation threshold, wherein the external electromagnetic field is a dynamic electromagnetic field having an RMS electric field strength less than the thermal excitation threshold, wherein the thermal excitation threshold for the RMS electric field strength is equal to or less than 50 V/m.

10. (canceled)

11. The method of claim 1, wherein the water has an ionic compound dissolved therein, the concentration of the ionic compound in the water being greater than 0.5 M.

12. (canceled)

13. The method of claim 11, wherein the ionic compound is NaOH or NaCl.

14. The method of claim 1, wherein the water is any one or more of seawater, salty water, river water, municipal water and wastewater.

15. The method of claim 1 including harvesting hydrogen generated in the photoelectrochemical cell.

16. The method of claim 1, wherein the semiconductor photoanode comprises a metal oxide at the interface, wherein the metal oxide is titanium dioxide or iron oxide.

17. (canceled)

18. Apparatus for photoelectrochemical generation of hydrogen from water splitting, the apparatus comprising:
a photoelectrochemical cell having:
an anode compartment and a cathode compartment in fluid communication with one another, the anode compartment and cathode compartment being arranged to receive water,
a semiconductor photoanode mounted in the anode compartment to contact water held therein
a photocathode mounted in the cathode compartment to contact water held therein,
circuitry to permit charge transfer between the photoanode and photocathode;
an electromagnetic field generator arranged to apply an external electromagnetic field across an interface between the semiconductor photoanode and water,
wherein the photoelectrochemical cell is transparent to radiation capable of promoting electrons in the semiconductor photoanode to the conduction band, and
wherein the electromagnetic field generator is arranged to set properties of the electromagnetic field which increase susceptibility of water molecules to break up.

19. The apparatus of claim 18, wherein the photoelectrochemical cell comprises a window that is transparent to solar radiation.

20. The apparatus of claim 18, wherein the electromagnetic field generator includes a pair of plate electrodes arranged on opposite sides of the photoelectrochemical cell.

21. The apparatus of claim 20, wherein each of the pair of plate electrodes is sized to generate a substantially uniform field within the photoelectrochemical cell.

22. The apparatus of claim 18, wherein the electromagnetic field generator comprises a voltage source for applying a static electric field across the interface between the semiconductor photoanode and the water.

23. (canceled)

24. (canceled)

25. The apparatus of claim 18, wherein the electromagnetic field generator includes a microwave source for applying a dynamic electromagnetic field across the interface between the semiconductor photoanode and the water, the dynamic electromagnetic field having a frequency selected such that oscillation of the field have a period that is the same order of magnitude as the relaxation time of hydrogen bonds in the water.

26. (canceled)

27. (canceled)

28. (canceled)

29. (canceled)

30. The apparatus of claim 28, wherein the output power is equal to or less than 15 W.

31. (canceled)

32. (canceled)

33. (canceled)

34. (canceled)

35. (canceled)

36. The apparatus of claim 18, wherein the photoelectrochemical cell includes a gas outlet for harvesting hydrogen generated in the photoelectrochemical cell.

37. (canceled)

38. (canceled)
